(19) United States
(12) Patent Application Publication
(10) Pub. No.: US 2008/0225547 A1
(43) Pub. Date: Sep. 18, 2008

(54) LED vehicle lamp

(76) Inventors: Thomas W. Rogers, Marshall, MI (US); Marcia Albright, Coldwater, MI (US)

Correspondence Address: MCDONALD HOPKINS LLC, 600 Superior Avenue, East, Suite 2100, CLEVELAND, OH, 44114-2653, US

(21) Appl. No.: 11/906,417

(22) Filed: Oct. 2, 2007

Related U.S. Application Data
(60) Provisional application No. 60/848,823, filed on Oct. 2, 2006.

(51) Int. Cl. B60Q 1/00

(52) U.S. Cl. 362/548

(57) ABSTRACT

Apparatus, methods, and other embodiments associated with retrofitting existing vehicle lamps are described herein. In one embodiment, an apparatus for retrofitting an existing vehicle lamp comprises a circuit board, a light emitting diode, a plug, and a lens. The light emitting diode is positioned on the circuit board. The plug is in electrical communication with the light emitting diode. The plug is arranged to be placed in electrical communication with a vehicle electrical system when the plug is inserted into a socket of the existing vehicle lamp. The lens is arranged to be securable to a base of the existing vehicle lamp.

### CROSS-REFERENCE TO RELATED APPLICATIONS

This application claims priority from U.S. Provisional Patent Application No. 60/848,823, entitled “LED VEHICLE LAMP” and filed on Oct. 2, 2006, which is hereby incorporated by reference in its entirety.

### FIELD OF THE INVENTION

The present invention relates generally to vehicle lamps and, more particularly, to arrangements for retrofitting vehicle lamps and methods for achieving such retrofitted arrangements.

### BACKGROUND

Vehicles, such as automobiles, trucks, trailers, and other such vehicles that travel on public thoroughfares, are typically equipped with a number of safety features. For example, such vehicles are commonly equipped with a series of lights or reflectors that alert other drivers as to the location and size of the vehicle during both daytime and nighttime driving. Vehicle lamps, such as sidemarker lamps and clearance lamps, are examples of lights that assist in the safe operation of a vehicle. Sidemarker lamps are generally mounted on the sides of a motor vehicle, near the front and rear of the vehicle, to indicate to other drivers the overall length of a vehicle. Clearance lamps are generally mounted on the front and rear of vehicles, near the sides of the vehicle, to indicate to other drivers the overall width of a vehicle.

Sidemarker lamps and clearance lamps normally include a light source, such as a light bulb. It is common for the service life of a light source to be shorter than the service life of a vehicle. When a light source fails, it may be unsafe to operate the vehicle on public thoroughfares. Under such conditions, there is a need for apparatus and methods for correcting the failure of the light source.

### SUMMARY OF INVENTION

Apparatus, methods, and other embodiments associated with retrofitting existing vehicle lamps are described herein. In one embodiment, an apparatus for retrofitting an existing vehicle lamp comprises a circuit board, a light emitting diode, a plug, and a lens. The light emitting diode is positioned on the circuit board. The plug is in electrical communication with the light emitting diode. The plug is arranged to be placed in electrical communication with a vehicle electrical system when the plug is inserted into a socket of the existing vehicle lamp. The lens is arranged to be securable to a base of the existing vehicle lamp.

### BRIEF DESCRIPTION OF THE SEVERAL VIEWS OF THE DRAWING

In the accompanying drawings, which are incorporated in and constitute a part of this specification, embodiments of the invention are illustrated, which, together with a general description of the invention given above and the detailed description given below, serve to illustrate the principles of this invention. The drawings and detailed description are not intended to and do not limit the scope of the invention or the claims in any way. Instead, the drawings and detailed description only describe embodiments of the invention, and other embodiments of the invention not described are encompassed by the claims.

FIG. 1 is an exploded view of a vehicle lamp with an incandescent light bulb;

FIG. 2 is a perspective view of an vehicle lamp with light emitting diodes;

FIG. 3 is a cross-sectional view of the vehicle lamp illustrated in FIG. 2, taken along the line 3-3 of FIG. 2;

FIG. 4 is a cross-sectional view of the vehicle lamp illustrated in FIG. 2, taken along the line 4-4 of FIG. 3; and

FIG. 5 is an exploded view of the vehicle lamp of FIG. 2.

### DETAILED DESCRIPTION OF THE INVENTION

The Detailed Description of the Invention merely describes embodiments of the invention and is not intended to limit the scope of the claims in any way. Indeed, the invention as described by the claims is broader than and unlimited by the embodiments described herein, and the terms in the claims have their full ordinary meaning.

As described herein, apparatus and methods may be designed and arranged to replace, retrofit, or otherwise correct failed light sources in safety lights attached to vehicles. The present application discloses embodiments for arrangements of novel apparatus for replacing, retrofitting, or correcting a failed vehicle safety light. In addition, the present application discloses embodiments for arrangements of novel methods for replacing, retrofitting, or correcting a failed vehicle safety light.

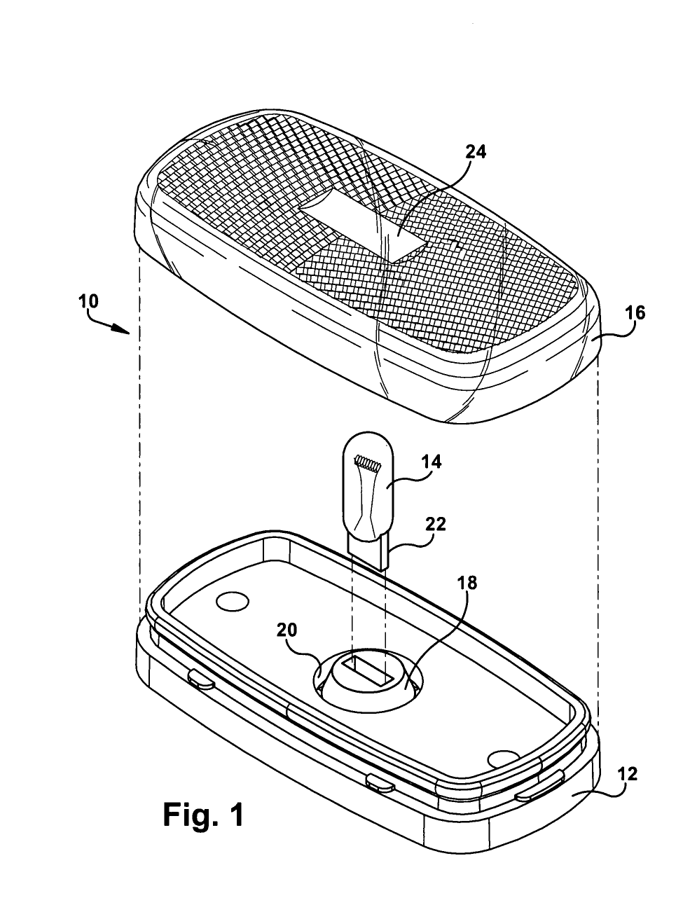

FIGS. 1 through 5 illustrate exemplary embodiments of vehicle lamps. FIG. 1 illustrates one such exemplary vehicle lamp 10. The vehicle lamp 10 includes a base 12 for securing the lamp 10 to a vehicle (not shown); a light source 14, such as an incandescent bulb; and a lens 16 that is arranged to attach to the base 12 so as to cover the light source 14. The base 12 may be secured or otherwise attached to the vehicle by screws, bolts, rivets, or other such fasteners.

The lens 16 may be arranged such that it is reversibly attached to the base 12. For example, the lens 16 and the base 12 may include attachment features, such as tabs and notches or ridges and grooves. Such attachment features may allow the lens 16 to be selectively snapped onto the base 12 (i.e., attached to the base 12) and selectively snapped off of the base 12 (i.e., removed from the base 12).

Referring again to FIG. 1, the base 12 is arranged to accept a socket 18 that is in electrical communication with the vehicle's electrical system. The socket 18 may be connected to the vehicle's electrical system by electrical wiring (not shown) leading from the socket 18 to internal components of the vehicle. The base 12 may include an aperture 20 arranged to accept the socket 18. The socket 18 may be placed into the aperture 20 to expose the socket 18 to the interior of the base 12. The socket 18 may be selectively secured in the aperture 20 of the base 12 by attachment features. In addition to arrangements where the socket 18 may be snapped into or snapped out of the aperture 20, attachment features may be arranged to secure the socket 18 in the aperture 20 by engaging the attachment features by rotating the socket 18 once it is placed inside the aperture 20.

In one embodiment, the light source is an incandescent bulb 14. The bulb 14 may include a post 22 that may be inserted into the socket 18 to secure the bulb 14 to the lamp 10. Once secured, the bulb 14 may be selectively illuminated by the vehicle's electrical system. Although the light source is described and illustrated as an incandescent bulb 14, it will be readily understood that many other light sources may be practiced with the embodiments of the present invention.

The lens 16 may include a window 24. The window 24 may be positioned on the lens such that, when the lens 16 is secured to the base 12, the window 24 is positioned above the bulb 14. Although the embodiment of FIG. 1 is illustrated and shown with one socket 18 and one light source 14, it will be understood that the embodiments described herein may be practiced with more than one socket 18 and more than one light source 14.

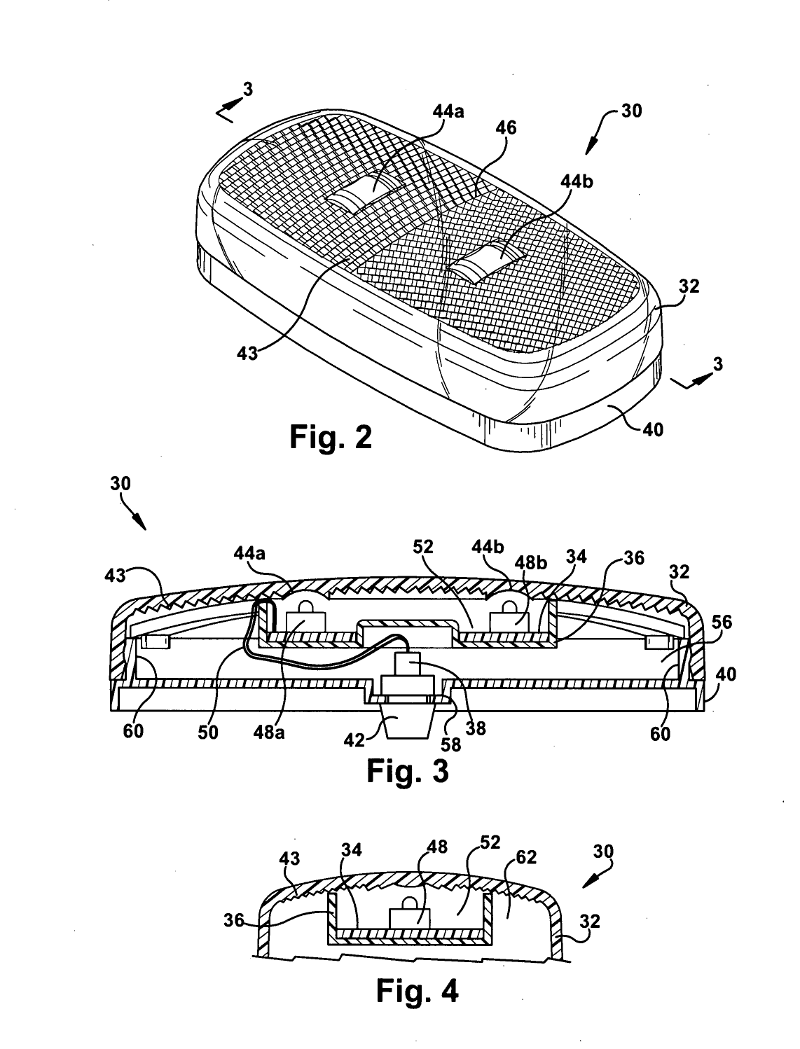

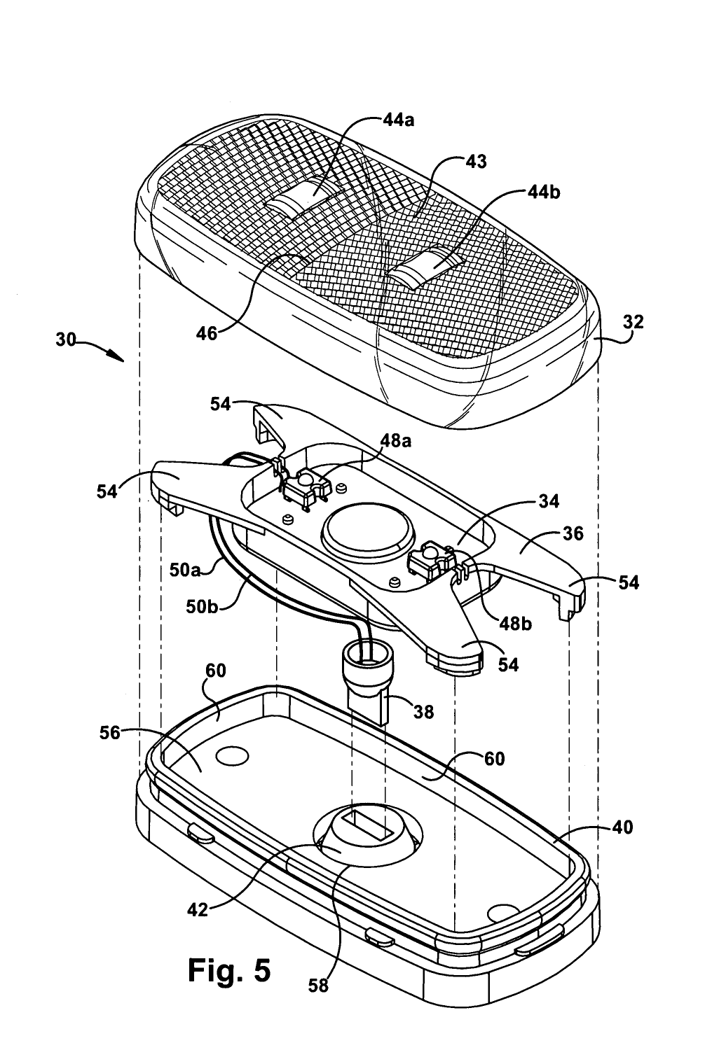

FIGS. 2 through 5 illustrate another exemplary vehicle lamp 30. The vehicle lamp 30 is arranged such that the light source is at least one light emitting diode (LED). As best seen in FIG. 5, such an LED vehicle lamp 30 may include a lens 32, a circuit board 34, an insert member 36, a plug 38, a base 40, and a socket 42. As will be further discussed in detail below, the incandescent vehicle lamp 10 illustrated in FIG. 1 may be retrofit by the interchange of certain components to form the LED vehicle lamp 30 illustrated in FIGS. 2 through 5. Specifically, the incandescent bulb 14 and lens 16 illustrated in FIG. 1 may be removed and discarded. The base 12 and socket 18 illustrated in FIG. 1 may be maintained and reused. The lens 32, circuit board 34, and insert member 36 illustrated in FIGS. 2 through 5 may then be assembled with the existing base 12 and socket 18 to form an LED vehicle lamp 30. In such an exemplary embodiment, the existing base 12 and socket 18 do not have to be removed from the vehicle to retrofit an incandescent vehicle lamp 10 to a LED vehicle lamp 30. Thus, such arrangements provide for convenient and simple apparatus and methods for retrofitting vehicle lamps from one light source to another light source.

Referring again to FIGS. 2 through 5, the lens 32 may include a generally textured and translucent surface 43. The translucent surface 43 may include a pair of transparent windows 44a and 44b symmetrically offset from a centerline 46 bisecting the lens 32. As is shown, the circuit board 34 includes a pair of LEDs 48a and 48b. A pair of wires 50a and 50b connects the plug 38 to the circuit board 34. As will be described below, the plug 38 and wires 50a and 50b are arranged so as to provide electrical current to the LEDs 48a and 48b through the circuit board 34 to power and illuminate the LEDs 48a and 48b. Although the embodiment illustrated in FIGS. 2 through 5 show a pair of LEDs 48a and 48b, it will be understood that embodiments of the present invention may be practiced with any number of LEDs or practiced with sources of light other than incandescent bulbs and LEDs.

In an exemplary embodiment, the insert member 36 or bridge member includes a recessed area 52 and four legs 54 extending outward from the recessed area 52. The recessed area 52 is arranged to accommodate and secure the circuit board 34 within the recessed area 52. Although the exemplary embodiment illustrates a circuit board 34 nested in an insert member 36, it will be readily understood by those skilled in the art that the circuit board may be fully integrated into the insert member to form a single component. In addition, the present invention should not be deemed as limited to any specific illustrated or described arrangement for securing a circuit board to an insert member.

The base 40 includes an inner chamber or cavity 56 to accommodate the insert member 36 and an aperture 58 arranged to accommodate the socket 42. The aperture 58 and socket 42 may optionally include a series of tabs and notches (not shown) for reversibly securing the socket 42 to the base 40. The legs 54 of the insert member 36 may be arranged to occupy the chamber 56 of the base 40. The dimensions of the legs 54 may be selected such that when the insert member 36 is positioned into the chamber 56 of the base 40, there is little or no clearance between the legs 54 and the walls 60 of the chamber 56. Such an arrangement ensures that the LEDs 48a and 48b remain generally in a static position relative to the base 40 and lens 32 once the lamp 30 is assembled. Although the insert member 36 is described and illustrated as having four legs 54, it will be readily understood that an insert member may be arranged with any number of legs, extensions, or any structure that properly locates the insert member in a vehicle lamp base.

It will be readily appreciated that the base 12 illustrated in FIG. 1 and the base 40 illustrated in FIGS. 2 through 5 may be substantially similar or identical. In addition, it will be appreciated that any description of the base 12 illustrated in FIG. 1 may optionally apply to the base 40 illustrated in FIGS. 2 through 5, and any description of, the base 40 illustrated in FIGS. 2 through 5 may optionally apply to the base 12 illustrated in FIG. 1.

As is best seen in FIGS. 3 and 4, the lens 32 includes an inner cavity 42. As similarly described for the inner chamber 36 of the base 20, the dimensions of the legs 54 correspond to the size and shape of the cavity 42 of the lens 32. In an exemplary embodiment, the dimensions of the legs 54 provide at least some clearance between the outer dimensions of the legs 54 and the inner dimensions of the cavity 42 of the lens 32. Optionally, each leg 54 may include a tab (not shown) extending from the end of the leg 54. This tab can be arranged to fit into a ridge or notch (not shown) along the walls 60 of the inner chamber 36 of the base 20 or a similar ridge or notch (not shown) along the walls of the inner cavity 62 of the lens 32.

As discussed previously, the socket 42 may be arranged to be reversibly secured in the aperture 58 of the base 40. The socket 42 includes wiring that is connected to the vehicle electrical system to supply power, such as electrical current, to any device inserted into the socket 42. The plug 38 is arranged to fit into the socket 42 so as to provide electrical current to the circuit board 34 and the LEDs 48a and 48b seated on the circuit board 34.

As is best illustrated in FIG. 3, the insert member 36 may be arranged such that, when the plug 38 is inserted into the socket 42 and the insert member 36 is seated in the chamber 56 of the base 40, the insert member 36 forms a bridge over the bottom of the chamber 56 and provides a space underneath the insert member 36. The plug 38 and any excess wiring 50 from the circuit board 34 may be accommodated in such a space between the insert member 36 and the bottom of the chamber 56. Such an arrangement increases the convenience and simplicity of assembly of the LED vehicle lamp 30.

The lens 32 may be arranged to be reversibly secured to the base 40. Any method for reversibly securing the lens 32 to the base 40 is included in this disclosure. For example, the lens 32 may include a tab or other raised feature that fits along a ridge or notch (not shown) included in the base 32. Once the insert member 36 is located in the inner chamber 56 of the base 40 or optionally snapped into the chamber 56 or the inner cavity 62 of the lens 40, the lens 32 can be secured to the base 50 to complete the assembly of the LED vehicle lamp 30.

The LEDs 48a and 48b are located on the circuit board 34 such that when the LED vehicle lamp 30 is assembled, the LEDs 48a and 48b are aligned under a pair of transparent windows 44a and 44b located in the lens 32. In an embodiment, the transparent windows 44a and 44b are convex such that light emitting from the LEDs 48a and 48b is focused and magnified by the transparent windows 44a and 44b.

The apparatus as described herein are novel arrangements for vehicle lamps. In addition, components as described may be arranged to accommodate the replacement, retrofit, or correction of light sources in an existing vehicle lamp. In one embodiment, a vehicle lamp 10 with a failed incandescent bulb 14 as its light source may be retrofitted to an LED vehicle lamp 30. As will be described below, the lens 32, insert member 36, and plug 38 as illustrated and described herein may be arranged such that the base 12 and socket 18 of the incandescent vehicle lamp 10 illustrated in FIG. 1 may be reused to retrofit or convert the incandescent lamp 10 to an LED vehicle lamp 30. Such methods may eliminate the need to replace the base 12 of a lamp 10 previously installed on a vehicle. In addition, such an arrangement may eliminate that need to wire a new socket to the electrical system of the vehicle.

The plug 38 may be arranged to simulate the base 22 of an incandescent bulb 14. Such an arrangement allows the plug 38 to be inserted into an existing socket 18 that normally accommodates a common incandescent bulb 14. The plug 38 thus may relay electrical current from the vehicle's electrical system to the LEDs 48a and 48b seated on the circuit board 34. Although the plug 38 is described and illustrated as simulating the base 22 of an incandescent bulb 14, it will be readily understood that a plug may be arranged to simulate the base or other connecting feature of any light source, thus providing for the retrofitting of any number and variety of vehicle lamps.

The insert member 36 may be arranged to sit in the base 12 as described above. The outer dimensions of the legs 54 may be selected to fit into the base 12, leaving little clearance between the inner dimensions of the base 12 and the outer dimension of the legs 54 to statically position the LEDs 48a and 48b with respect to the base 12. The lens 32 of the LED vehicle lamp 30 may be arranged to snap onto the base 12 of the incandescent vehicle lamp 10 such that the lens 32 is secured to the base 12, as described above.

Such an arrangement for the lens 32, the insert base 36, and the plug 38 of the LED vehicle lamp 30 allows for methods of retrofitting or converting existing incandescent vehicle lamps 10 into LED vehicle lamps 30. One exemplary method includes removing the existing lens 16 of an incandescent vehicle lamp 10. Removing the existing incandescent light bulb 14 from the socket 18. Inserting the plug 38 of the LED vehicle lamp 30 into the socket 18. Placing the insert member 36 into the base 12. Tucking the excess wiring 50 between the insert member 36 and the base 12. Finally, securing the lens 32 of the LED vehicle lamp 30 to the existing base 12 to form an LED vehicle lamp 30.

Although exemplary embodiments have been illustrated and described herein as having two LEDs, it will be readily understood by those skilled in the art that any number of LEDs arranged in any manner may be utilized in the practice of embodiments of this invention. In addition, lenses have been illustrated and described as having two windows. It will be readily understood by those skilled in the art that any number of windows arranged in any manner may be utilized in the practice of embodiment of this invention. Such windows may be arranged such that a window is located above each LED when the lens is secured to a base.

While the invention has been described with reference to the preferred embodiment, other embodiments, modifications, and alternations may occur to one skilled in the art upon reading and understanding of this specification and are to be covered to the extent that they fall within the scope of the appended claims. Indeed, the invention as described by the claims is broader than and unlimited by the preferred embodiment, and the terms in the claims have their full and ordinary meaning.

We claim:

1. Apparatus for retrofitting an existing vehicle lamp, the apparatus comprising:
a circuit board;
a light emitting diode positioned on the circuit board;
a plug in electrical communication with the light emitting diode and arranged to be placed in electrical communication with a vehicle electrical system by inserting the plug into an existing vehicle lamp socket; and
a lens securable to an existing vehicle lamp base.

2. The apparatus of claim 1, further comprising an insert member positionable within a cavity of the existing vehicle lamp base.

3. The apparatus of claim 2, wherein the insert member includes a recess.

4. The apparatus of claim 3, wherein the circuit board is positioned in the recess.

5. The apparatus of claim 2, wherein the circuit board is integral with the insert member.

6. The apparatus of claim 2, wherein the insert member further comprises:
a body; and
a leg extending from the body, wherein the leg is located proximate to a sidewall of the existing vehicle lamp base when the insert member is positioned in the cavity of the existing vehicle lamp base.

7. The apparatus of claim 6, wherein the insert member further comprises a tab and the lens further comprises a notch, wherein the tab engages the notch to secure the insert member to the lens.

8. The apparatus of claim 6, wherein the existing vehicle lamp base includes a notch and the insert member further comprises a tab, wherein the notch engages the tab to secure the insert member to the existing vehicle lamp base.

9. The apparatus of claim 6, wherein when the insert member is positioned in the cavity of the existing vehicle lamp, the body of the insert member is spaced above and apart from a bottom surface of the cavity.

10. The apparatus of claim 2, wherein the insert member further comprises:
a body; and
four legs extending from the body, wherein each leg is located proximate to a sidewall of the existing vehicle lamp base when the insert member is positioned in the cavity of the existing vehicle lamp base.

11. The apparatus of claim 1, wherein the lens includes a window.

12. The apparatus of claim 11, wherein when the circuit board is positioned in the existing vehicle lamp base and the lens is secured to the existing vehicle lamp base, the window is positioned above the light emitting diode.

13. The apparatus of claim 11, wherein the window is convex.

14. The apparatus of claim 1, wherein the lens is reversibly securable to the existing vehicle lamp base.

15. A kit for retrofitting an existing vehicle lamp, comprising:
a circuit board assembly, comprising:
a circuit board;
a light emitting diode positioned on the circuit board; and
a plug in electrical communication with the light emitting diode and arranged to be placed in electrical communication with a vehicle electrical system by inserting the plug into an existing vehicle lamp socket;
an insert member positionable within a cavity of an existing vehicle lamp base; and
a lens securable to the existing vehicle lamp base.

16. A method for retrofitting an existing vehicle lamp, comprising:
removing an existing lens from the existing vehicle lamp;
removing an existing light source from a socket of the existing vehicle lamp;
providing a circuit board, a light emitting diode positioned on the circuit board, and a plug in electrical communication with the light emitting diode;
inserting the plug into the socket of the existing vehicle lamp;
positioning the circuit board proximate to the existing vehicle lamp base;
providing a lens; and
securing the lens to the existing vehicle lamp base.

17. The method of claim 16, further comprising:
providing an insert member, the insert member including a recess;
positioning the circuit board in the recess; and
positioning the insert member at least partially in a cavity of the existing vehicle lamp base.

18. The method of claim 17, further comprising:
positioning the insert member at least partially in the cavity of the existing vehicle lamp base such that a portion of the insert member is spaced above and apart from a bottom surface of the cavity.

19. The method of claim 16, further comprising:
providing the circuit board as an integral part of an insert member; and
positioning the insert member at least partially within a cavity of the existing vehicle lamp base.

20. The method of claim 19, further comprising:
positioning the insert member at least partially in the cavity of the existing vehicle lamp base such that a portion of the insert member is spaced above and apart from a bottom surface of the cavity.
